(19) United States
(12) Patent Application Publication
(10) Pub. No.: US 2011/0010223 A1
(43) Pub. Date: Jan. 13, 2011

(54) System and Method for Administering a Survey

(76) Inventor: William J. Mich, JR., Stony Brook, NY (US)

Correspondence Address: FROMMER LAWRENCE & HAUG, 745 FIFTH AVENUE- 10TH FL., NEW YORK, NY, 10151, US

(21) Appl. No.: 12/501,199

(22) Filed: Jul. 10, 2009

(51) Int. Cl. G06Q 10/00; G06F 3/048; G06F 15/16; G06F 17/30

(52) U.S. Cl. 705/10; 715/739; 707/705; 707/E17.001

(57) ABSTRACT

In a survey according to an embodiment of the invention, a subject may select from a list of items, such as activities. The subject may be asked to narrow the selection and then to supply information related to each of the remaining items. For example, the subject may be asked to indicate how much money the subject spent in the past 30 days on each of the selected activities. The subject may then be asked to assume that the spending must be reduced and to select or classify activities accordingly. Surveys may include various types of items, selection criteria, and/or information gathering that may be related, e.g., to selected items.

Embodiments of the invention comprise surveys, computers and computer systems for administration of surveys, and computer-readable media encoded with instructions to cause computers or computer systems to administer surveys.

### COPYRIGHT NOTICE

A portion of the disclosure of this patent document contains material that is subject to copyright protection. The copyright owner has no objection to the facsimile reproduction by anyone of the patent document or the patent disclosure as it appears in the Patent and Trademark Office patent files or records, but otherwise reserves all copyrights whatsoever.

### BACKGROUND

It is sometimes desired to gauge values and attitudes, e.g., of the public as a whole or of one or more subgroups thereof. For example, knowledge of the issues considered most relevant by voters may be considered valuable in the course of a political campaign. Information about consumers' preferences is often valued by commercial providers of goods or services.

Opinion surveys are commonly used to solicit, e.g., this kind of information. A form of survey known in the art, for example, involves personally interviewing a number of subjects and recording and correlating the opinions stated by the subjects in their respective interviews. In addition to or instead of being interviewed, subjects may be asked to fill out a questionnaire, recording their answers, e.g., on a paper or electronic form.

The individual and collective results of any survey may be skewed, however, by factors that may include, e.g., the subjects' conscious and/or unconscious biases. Such skew may make the resulting information less reliable and hence less valuable. Substantial effort has therefore been put into mitigating the effects of such biases.

### BRIEF SUMMARY OF THE INVENTION

Embodiments of the invention relate to surveys and to methods and systems for administration of surveys to one or more subjects. In a survey according to an embodiment of the invention, a database of items may be maintained. A subject may, according to an embodiment of the invention, be instructed to choose some of the items and then to narrow the selection and/or to classify selected items according to one or more specified criteria. The subject may in an embodiment of the invention be instructed to provide information regarding some or all of the items. The subject may in embodiments of the invention select, classify, and/or give information in one or more stages, and any one or more of choice, classification, and/or giving information may be done one or multiple times and in any order.

For example, in an embodiment of the invention, a database may store, e.g., a list of activities that a subject may engage in. The subject may be asked to select some of the activities, e.g., the activities that the subject may have engaged in during the past 30 days. In an embodiment of the invention, the subject may then be asked to narrow the selection, e.g., according to one or more specified criteria.

After the subject has narrowed the selection, in an embodiment of the invention, the subject may then be asked to supply information about each of the remaining activities. For example, the subject may be asked to indicate the amount of money that the subject spent on each of the activities in the past 30 days. In an embodiment of the invention, the subject may then be told to assume a reduction in spending, e.g., 15% to 35%, and, based on that assumption, to select the activities that the subject would continue to engage in and to discard the others. In an embodiment of the invention, the subject may instead be instructed, e.g., to classify the activities, identifying those that the subject would continue to engage in without reducing spending on them, the activities that the subject would continue to engage in but with reduced spending, and those that the subject would give up entirely.

In embodiments of the invention, a survey, e.g., such as described above, may be administered, e.g., in connection with one or more computer systems. In embodiments of the invention, the computer systems include, e.g., a client, which the subject uses, and a server, which sends to the client information for presentation to the user and receives from the client the user's input in response. In embodiments of the invention, a survey may be administered, e.g., by an application that is resident on a computer that the subject uses.

An embodiment of the invention comprises a method of administering a survey to a user in connection with a computer system that comprises one or more processors, one or more databases operatively coupled to at least one of the processors, a computer-readable storage medium storing instructions capable of being executed by at least one of the processors and operatively coupled to at least one of the processors, and one or more interfaces operatively coupled to at least one of the processors. The method, according to such an embodiment, comprises transmitting through at least one of the interfaces information to cause an electronic display device to present a plurality of items from a list to the user and then receiving through at least one of the interfaces first user input that indicates selection of a first selected plurality of presented items. The method also comprises, in response to receiving the first user input, transmitting through at least one of the interfaces information to cause an electronic display device to present the first selected plurality of selected items and receiving through at least one of the interfaces second user input that indicates selection of a second selected plurality of presented items, where the second selected plurality of presented items is a subset of the first selected plurality of presented items, and the number of items in the second selected plurality of presented items has a previously specified relation to the number of items in the first selected plurality of presented items. In an embodiment of the invention, information associated with the second user input is caused to be stored in at least one of the databases.

In an embodiment of the invention, the method may comprise receiving through at least one of the interfaces third user input comprising a quantity representing an aggregate quantity associated with the items in the second selected plurality of presented items. According to such an embodiment, the method may comprise transmitting through at least one of the interfaces information to cause an electronic display device to present the second selected plurality of selected items and a reduced quantity that has a predetermined relation to the aggregate quantity and receiving through at least one of the interfaces fourth user input comprising selection of a third selected plurality of presented items, the third selected plurality of presented items being a subset of the second selected plurality of presented items. In an embodiment of the invention, information associated with the fourth user input is caused to be stored in at least one of the databases.

In an embodiment of the invention, the method may comprise receiving through at least one of the interfaces third user input comprising a plurality of quantities, each of the items in the second selected plurality of presented items being associated respectively with one of the quantities. The method may comprise at least one of the processors executing instructions retrieved from the computer-readable storage medium to calculate a first sum comprising the respectively associated quantity for each of the items in the second selected plurality of presented items and transmitting through at least one of the interfaces information to cause an electronic display device to present the second selected plurality of selected items, such that each of the items in the second selected plurality of selected items is presented in association with the quantity associated with the respective item.

The method may comprise receiving through at least one of the interfaces fourth user input comprising selection of a third selected plurality of presented items, the third selected plurality of presented items being a subset of the second selected plurality of presented items, and the sum of the quantities associated respectively with the items in the third selected plurality of presented items having a previously specified relation to the first sum. In an embodiment of the invention, information associated with the fourth user input is caused to be stored in at least one of the databases.

In an embodiment of the invention, each of the items identifies a particular activity that a person may take part in.

In an embodiment of the invention, the method may comprise receiving through at least one of the interfaces demographic information associated with the user, and at least one of the processors executing instructions retrieved from the computer-readable storage medium that cause the demographic information to be stored in at least one of the databases. In an embodiment of the invention, the list of activities may have been selected based on the demographic information.

In an embodiment of the invention, each quantity associated with a respective activity designates an amount of money spent by the user on the activity within a specified period of time. Alternatively, in an embodiment of the invention, each quantity associated with a respective activity designates an amount of time spent by the user on the activity within a specified period of time.

In an embodiment of the invention, the number of items in the second selected plurality of presented items is approximately half of the number of items in the first selected plurality of presented items. In an embodiment of the invention, the sum of the quantities associated respectively with the items in the third selected plurality of presented items is between sixty-five percent and eighty-five percent of the first sum.

Embodiments of the invention also comprise computers and/or computer systems configured to carry out any, some, or all of the described methods. Embodiments of the invention comprise computer-readable storage media encoded with instructions that cause computers and/or computer systems to carry out any, some, or all of the described methods.

### BRIEF DESCRIPTION OF THE DRAWINGS

FIG. 1 depicts the flow of a survey according to an embodiment of the invention.

FIG. 2 is a block diagram of a computer system according to the prior art.

FIG. 3 is a block diagram of networked computer systems according to the prior art.

FIG. 4 is an overview of computerized administration of a survey according to an embodiment of the invention.

FIG. 5 depicts acquiring demographic information from a user in an embodiment of the invention.

FIG. 6 is a schematic representation of a Web page for acquiring demographic information from a user in an embodiment of the invention.

FIG. 7 is an example of a welcome page that may be presented to a user in connection with an embodiment of the invention.

FIG. 8 depicts a flow of presenting information to a user and receiving the user's input according to an embodiment of the invention.

FIG. 9 is an example of a page that may be presented to a user in connection with the flow of FIG. 8 according to an embodiment of the invention.

FIG. 10 is a schematic representation of a confirmation dialog according to an embodiment of the invention.

FIG. 11 depicts a flow of presenting information to a user and the user's narrowing of a selection and providing other information according to an embodiment of the invention.

FIGS. 12 and 13 are examples of pages that may be presented to a user in connection with the flow of FIG. 11 according to an embodiment of the invention.

FIG. 14 depicts a flow of presenting information to a user and the user's further narrowing of a selection according to an embodiment of the invention.

FIG. 15 is an example of a page that may be presented to a user in connection with the flow of FIG. 14 according to an embodiment of the invention.

### DETAILED DESCRIPTION OF PREFERRED EMBODIMENTS

Embodiments of the invention relate variously to kinds of surveys, methods of administering surveys, and computer systems for administering such surveys and/or for recording and/or analyzing the results. For example, in a survey according to an embodiment of the invention, a subject may be asked to select a plurality of items, e.g., from a list, based on one or more specified criteria. The subject may then be instructed to narrow the selection further based, e.g., on one or more other specified criteria, and more than one stage of narrowing or selecting may take place. Information may be obtained from the subject at one or more times during the survey, and, e.g., one or more of the criteria used to narrow the selection may relate to that information.

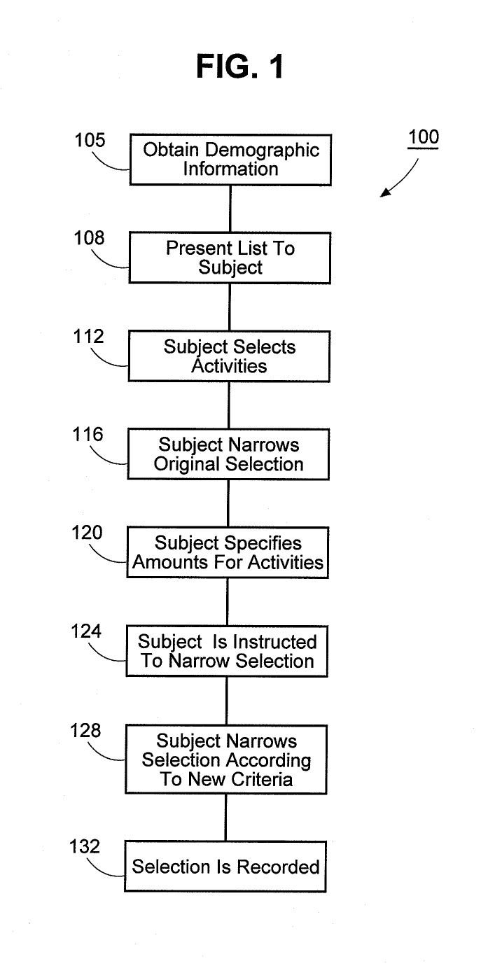

For example, in an embodiment of the invention, a subject may answer a survey intended to identify those activities that the subject is most likely to take part in. FIG. 1 depicts the flow 100 of such a survey according to an embodiment of the invention.

In an embodiment of the invention such as FIG. 1 depicts, the subject may be asked in block 105 for demographic or other information, such as, e.g., the subject's name, age, marital status, or household income, among other possibilities. Alternatively, some or all demographic information about the subject may in an embodiment of the invention already have been recorded, e.g., in a database, and this step may be skipped. In an embodiment of the invention, demographic information may not be recorded for some or all of the subjects.

The subject may in block 108 be presented with a list of items. For example, in an embodiment of the invention, the list may include activities that the subject may engage in. It will be appreciated, however, that the nature and/or number of activities or other items presented to the user may vary depending on the embodiment of the invention. The particular list of activities presented to the subject may or may not reflect the subject's demographic information.

The discussion of embodiments of the invention here, in connection with FIG. 1, and elsewhere may refer to a subject or user being presented with one or more lists of activities and/or to the subject or user selecting one or more activities so presented. Any reference to activities, lists of activities, or both does not limit the scope of the invention, but is intended merely to illustrate certain embodiments of the invention. The list of items may in an embodiment of the invention, and depending on, e.g., the purpose of the survey, comprise items in addition to or instead of such activities, such as, for example, groceries, types of restaurants, charitable causes, or political issues, among other possibilities.

In block 112, according to an embodiment of the invention, the subject is instructed to select some of the presented activities. In an embodiment of the invention, for example, the subject may be told to select activities that meet one or more criteria, and the subject may be given guidelines regarding the number of activities to select. For example, in an embodiment of the invention, the subject may be asked to select between fifty and ninety activities that the subject engaged in within the past month. It will be appreciated that any one or more of such criteria, any numerical guidelines, or both, may vary depending on the embodiment of the invention, reflecting, e.g., the nature of the listed items and/or the purpose of the survey, among other possibilities.

After the initial selection of items in block 112, the subject may then in an embodiment of the invention be instructed to narrow the selection in block 116, e.g., according to one or more specified criteria. For example, in an embodiment of the invention, the subject may be asked to choose half of the activities that the subject selected in block 112, and the subject may be told to select, e.g., the activities that are most important to the subject.

Any one or more of such criteria, any numerical guidelines, or both, may vary depending on the embodiment of the invention, reflecting, e.g., the nature of the listed items and/or the purpose of the survey, among other possibilities. For example, in embodiments of the invention, the subject may be told to select, e.g., 25% of the activities, or 75% of them, or just ten activities, depending, e.g., on the design and/or purpose of the survey. Criteria for the selection, instead of or in addition to choosing the “most important” of the listed activities, may include, e.g., the activities on which the subject spent the most time or money, activities that the subject enjoyed the most, and/or any other criterion or criteria.

Having narrowed the selection of activities further in block 116, in an embodiment of the invention, the subject may then be asked in block 120 to disclose some quantity that may be related to the selected activities individually or in aggregate. For example, in an embodiment of the invention, the subject may be asked to indicate how much money the subject spent in the past month on each respective selected activity. It will be appreciated that the specified quantities need not be amounts of money: examples of other quantities that may be requested according to an embodiment of the invention may include, among others, the amount of time spent on each activity and/or the number of occasions on which the subject engaged in each activity.

In block 124, the subject may be instructed to narrow the selection further, and, in an embodiment of the invention, the subject may be instructed to apply, e.g., one or more criteria related to the quantity or quantities provided in block 120. For example, in an embodiment of the invention, the quantities may be the amount of money that the subject spent on each of the respective activities in the past 30 days, and the subject may be instructed to select activities that the subject would keep, assuming, e.g., a 15% to 35% reduction in spending. The amount or range of amounts may vary significantly in an embodiment of the invention, and other criteria, including without limitation criteria wholly unrelated to cost or spending, may be specified in addition to or instead of the foregoing.

In an embodiment of the invention, the subject may in block 128 narrow the selection of activities, e.g., in response to the instructions provided in block 124. As previously described, this narrowing 128 may include, e.g., choosing to keep some activities and to discard others. In addition to or instead of some or all of the foregoing, in an embodiment of the invention, the subject may be instructed to identify, e.g., activities that the user would keep but reduce the spending on to satisfy the specified constraint.

After the subject has further narrowed and/or classified activities in block 128, in an embodiment of the invention, information gathered from the subject, including without limitation, e.g., some or all of the demographic information and/or some or all of the selections made by the subject, may be recorded in block 132.

It will be appreciated that, according to an embodiment of the invention, a subject may be instructed to select and/or classify items, e.g., according to one or more criteria other than or in addition to some or all of the criteria specified above. It will also be appreciated that, according to an embodiment of the invention, the subject may go through fewer or more stages of selection and/or classification than in the depicted embodiments.

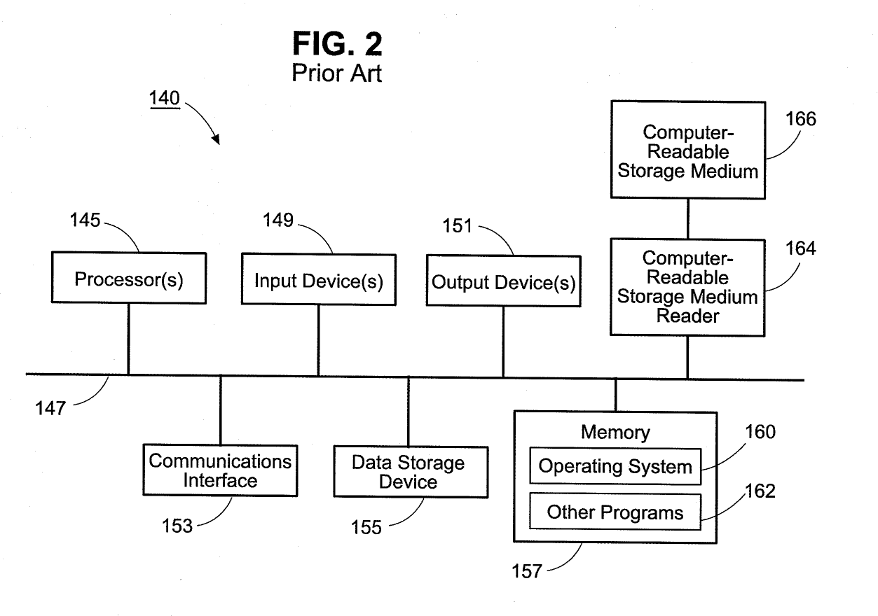

Methods of administration of a survey, e.g., as described above, may be practiced using programmable digital computers. FIG. 2 is a block diagram of a representative prior art computer. The computer system 140 includes at least one processor 145, such as, e.g., an Intel Core™ 2 microprocessor or a Freescale™ PowerPC™ microprocessor, coupled to a communications channel 147. The computer system 140 further includes at least one input device 149 such as, e.g., a keyboard or mouse, at least one output device 151 such as, e.g., a CRT or LCD display, a communications interface 153, a data storage device 155 such as a magnetic disk or an optical disk, and memory 157 such as Random-Access Memory (RAM), each coupled to the communications channel 147. The communications interface 153 may be coupled to a network (not depicted) such as the Internet.

Although the computer system 140 is shown in FIG. 2 to have only a single communications channel 147, a person skilled in the relevant arts will recognize that a computer system may have multiple channels (not depicted), including for example one or more busses, and that such channels may be interconnected, e.g., by one or more bridges. In such a configuration, components depicted in FIG. 2 as connected by a single channel 147 may interoperate, and may thereby be considered to be coupled to one another, despite being directly connected to different communications channels. Additionally, a connection between or among any one or more components and/or channels may include or otherwise be mediated by one or more interfaces.

One skilled in the art will recognize that, although the data storage device 155 and memory 157 are depicted as different units, the data storage device 155 and memory 157 can be parts of the same unit or units, and that the functions of one can be shared in whole or in part by the other, e.g., as RAM disks, virtual memory, etc. It will also be appreciated that any particular computer may have multiple components of a given type, e.g., processors 145, input devices 149, communications interfaces 153, etc.

The data storage device 155 and/or memory 157 may store instructions executable by one or more processors 145 or kinds of processors, data, or both. Some groups of instructions, possibly grouped with data, may make up one or more programs, which may include an operating system 160 such as Microsoft Windows XP® or Vista™, Linux®, Mac OS®, or Unix®. Other programs 162 may be stored instead of or in addition to the operating system. It will be appreciated that a computer system may also be implemented on platforms and operating systems other than those mentioned. Any operating system 160 or other program 162, or any part of either, may be written using one or more programming languages such as, e.g., Java®, C, C++, C#, Visual Basic®, VB.NET®, Perl, Ruby, Python, or other programming languages, possibly using object oriented design and/or coding techniques.

One skilled in the art will recognize that the computer system 140 may also include additional components and/or systems, such as network connections, additional memory, additional processors, network interfaces, and/or input/output busses, for example. One skilled in the art will also recognize that the programs and data may be received by and stored in the system in alternative ways. For example, a computer-readable storage medium (CRSM) reader 164, such as, e.g., a magnetic disk drive, magneto-optical drive, optical disk drive, or flash drive, may be coupled to the communications bus 147 for reading from a computer-readable storage medium (CRSM) 166 such as, e.g., a magnetic disk, a magneto-optical disk, an optical disk, or flash RAM. Alternatively, one or more CRSM readers may be coupled to the rest of the computer system 140, e.g., through a network interface (not depicted) or a communications interface 153. In any such configuration, however, the computer system 140 may receive programs and/or data via the CRSM reader 164. Further, it will be appreciated that the term “memory” herein is intended to include various types of suitable data storage media, whether permanent or temporary, including among other things the data storage device 155, the memory 157, and the CSRM 166.

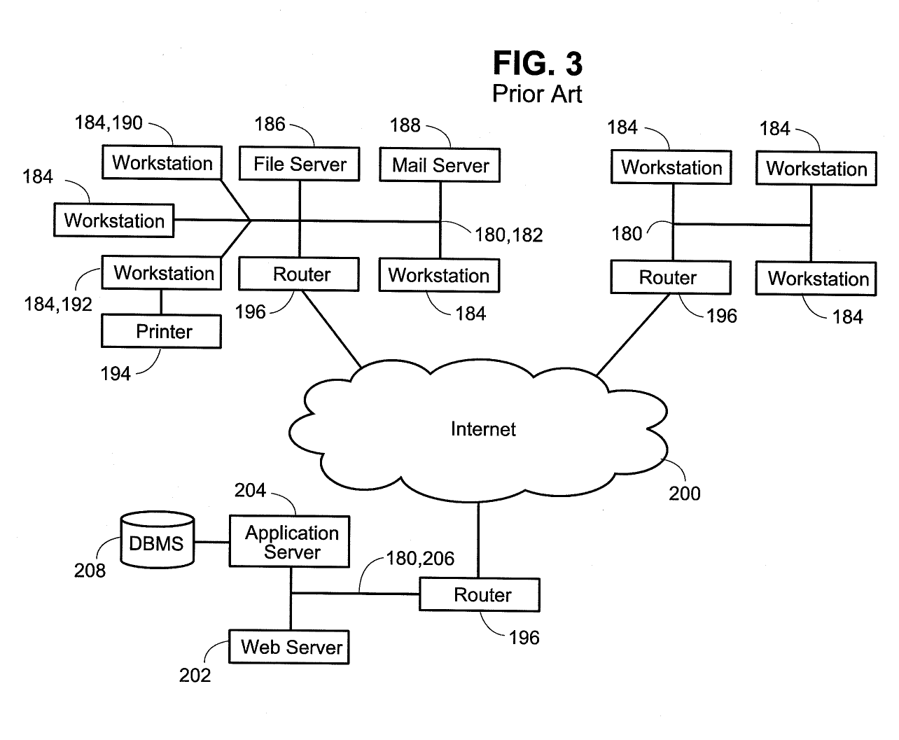

Two or more computer systems 140 may be connected, e.g., in one or more networks, via, e.g., their respective communications interfaces 155 and/or network interfaces (not depicted). FIG. 3 is a block diagram of representative prior art interconnected networks 180, such as may be useful in connection with embodiments of the invention.

A network 182 may, for example, connect one or more workstations 184 with each other and with other computer systems, such as file servers 186 or mail servers 188. The connection may be achieved tangibly, e.g., via Ethernet® or optical cables, or wirelessly, e.g., through use of modulated microwave signals according to the IEEE 802.11 family of standards. A computer system that participates in the network may send data to another computer system in the network via the network connection.

One use of a network 180 is to enable a computer system to provide services to other computer systems, consume services provided by other computer systems, or both. For example, a file server 186 may provide common storage of files for one or more of the workstations 190 on a network 182. A workstation 190 sends data including a request for a file to the file server 186 via the network 182 and the file server 186 may respond by sending the data from the file back to the requesting workstation 190.

As will be recognized by those skilled in the relevant art, the terms “workstation,” “client,” and “server” are used herein to describe a computer's function in a particular context. A workstation may, for example, be a computer that one or more users work with directly, e.g., through a keyboard and monitor directly coupled to the computer system. A computer system that requests a service through a network is often referred to as a client, and a computer system that provides a service is often referred to as a server. But any particular workstation may be indistinguishable in its hardware, configuration, operating system, and/or other software from a client, server, or both.

Further, a computer system may simultaneously act as a workstation, a server, and/or a client. For example, as depicted in FIG. 3, a workstation 192 is connected to a printer 194. That workstation 192 may allow users of other workstations on the network 182 to use the printer 194, thereby acting as a print server. At the same time, however, a user may be working at the workstation 192 on a document that is stored on the file server 186.

A network 182 may be connected to one or more other networks 180, e.g., via a router 196. A router 196 may also act as a firewall, monitoring and/or restricting the flow of data to and/or from a network 180 as configured to protect the network. A firewall may alternatively be a separate device (not pictured) from the router 196.

A network of networks 180 may be referred to as an internet. The term “the Internet” 200 refers to the worldwide network of interconnected, packet-switched data networks that uses the Internet Protocol (IP) to route and transfer data. A client and server on different networks may communicate via the Internet 200. For example, a workstation 190 may request a World Wide Web document from a Web Server 202. The Web Server 202 may process the request and pass it to, e.g., an Application Server 204. The Application Server 204 may then conduct further processing, which may include, for example, sending data to and/or receiving data from one or more other data sources. Such a data source may include, e.g., other servers on the same network 206 or a different one and/or a Database Management System (“DBMS”) 208.

The terms “client” and “server” may describe programs and running processes instead of or in addition to their application to computer systems described above. Generally, a (software) client may consume information and/or computational services provided by a (software) server.

A client and server, in this sense, may be in the same or different computer systems, depending on the implementation of the software and/or the users' needs, among many possible considerations. When the client and server are in separate computer systems, they may communicate, e.g., by using one or more facilities provided by one or more operating systems and/or other programs to send and receive data through one or more networks 180 that connect the computer systems.

The term “server” may be used without qualification, e.g., to refer to a computer system that provides a service, as described above, or to refer to one or more programs and/or processes in such a system, by virtue of which the computer system provides such a service. In some circumstances, the term “server” may, in a single discussion, refer at one time to a computer system and at another time to software in the computer system, with the precise meaning supplied by context. The term “client” may be similarly used in either or both senses of the term.

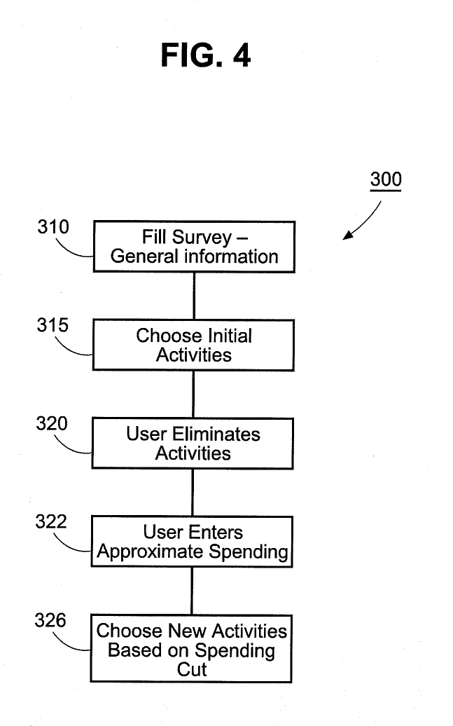

Embodiments of the invention involve administration of surveys to a subject, e.g., to obtain information that may relate to sales, promotion, and/or marketing, e.g., in connection with one or more computer systems such as described above. In connection with computerized administration of such a survey according to an embodiment of the invention, the subject may be referred to as a “user.” FIG. 4 depicts from a high level the flow of a computerized method 300 of administering such a survey to a user according to an embodiment of the invention.

A method such as depicted may begin, e.g., in block 310, in which general information about a user may be provided in response to a displayed request. The provided information may be, e.g., demographic information about the user, such as the user's name, age, household income, marital status, etc.

In block 315, according to an embodiment of the invention, the user may be presented with a list of, e.g., activities, such as the user and/or the user's family may participate in. In this block, the user may be asked to choose, e.g., 50-90 items from among the listed items.

In response to the user's identification of items in block 315, the user may then in an embodiment of the invention be presented in block 320 with the previously selected items from block 315, e.g., in a list. In this block, the user may be asked to narrow the selection. For example, in an embodiment of the invention, the user may be asked in block 320 to select half of the activities originally selected in block 315.

After the user's narrowing the selection, in an embodiment of the invention, block 322 may comprise specifying a quantity for each of the selected items. For example, the user may in an embodiment of the invention be asked to estimate how much money the user or the user's family spent on each of the selected activities in, e.g., the past month, quarter, six months, or year. Instead of or in addition to the time spent on each of the activities, the user may in an embodiment of the invention be asked to estimate how much time the user or the user's family spent on each of the selected activities in such a time period.

In block 325, in an embodiment of the invention, the user may be asked to assume a reduction, for example, of 15%-35%, in the total time or money (as applicable) available to spend on the selected activities as a whole. The user may then be asked to narrow the selection of activities to satisfy the new constraint.

In an embodiment of the invention, any or all information provided by the user in completing the survey may be provided, e.g., as input to a computer system. In response to receiving any or all such input, the computer system may cause some or all of it to be stored, e.g., in one or more databases. The stored information may then be available, e.g., for analysis, reporting, or both, and in, e.g., individual and/or aggregate form.

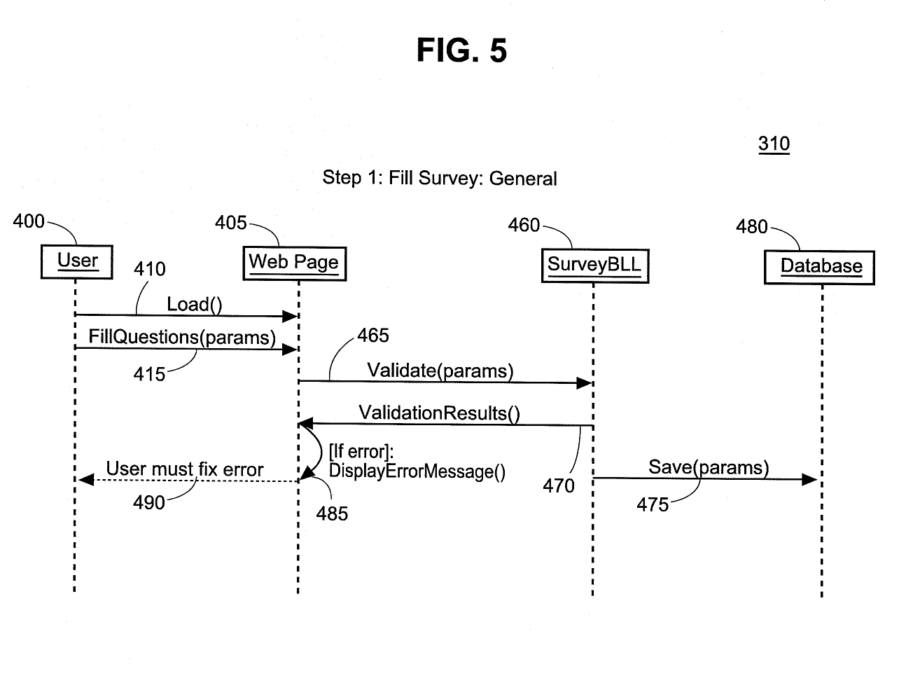

FIG. 5 illustrates the sequence of acquiring information, such as demographic information, from a user as in block 310 of FIG. 3, according to an embodiment of the invention. As depicted, these and other sequences occur in connection with an embodiment of the invention in a client-server environment, using an HTTP server and browser, but an embodiment of the invention may comprise a native application, e.g., installed on a workstation, that administers a survey, e.g., to a user of the workstation.

A user 400 in the depicted embodiment of the invention causes a Web page 405 to load 410. The Web page 405 may comprise, e.g., a Web-based form in which the user may supply certain personal and/or household information, as in operation 415.

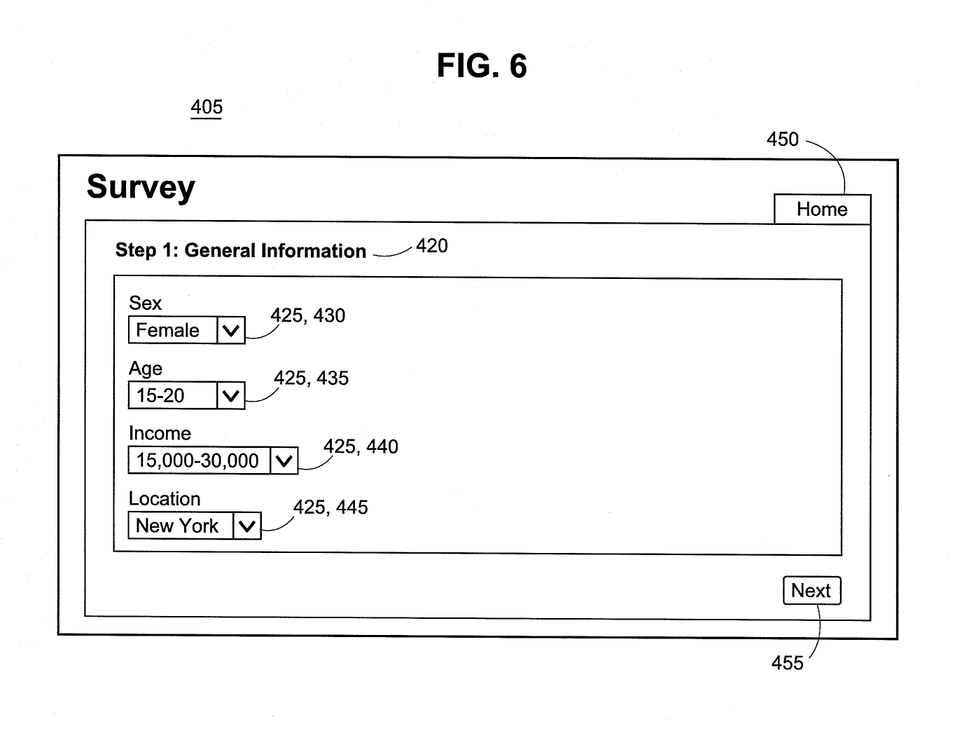

FIG. 6 depicts a basic Web page 405 such as may be used in connection with the sequence that FIG. 5 depicts. According to an embodiment of the invention, the page 405 comprises a label 420 that may indicate the purpose of the page and/or instruct the user. The depicted page 420, as in an embodiment of the invention, may be, e.g., an HTML form, which may comprise one or more HTML elements that a user may use to provide information. For example, as depicted, the form includes elements 420 for the input, respectively, of the user's 400 sex 430, age or age range 435, personal or household income or income range 440, and location 445. It will be appreciated by one skilled in the art that the particular elements, layout, and information solicited are merely examples and that, in an embodiment of the invention, other information may be solicited in addition to or instead of some or all of that depicted in FIG. 6.

In the embodiment of the invention that FIG. 6 depicts, the Web page 405 includes additional elements, e.g., for navigation between Web pages and, possibly equivalently, between steps of the depicted method 300 (FIG. 4). A button 450 labeled “Home” in an embodiment of the invention may lead the user to a starting page (not depicted) for the survey or application that administers the survey. Another button 455, labeled “Next” in FIG. 6, may cause submission of the HTML form 405 to a Web server.

Returning to FIG. 5, submission of the HTML form in the Web page 405 may in an embodiment of the invention cause, e.g., a Web application 465 that administers the survey (identified in FIG. 5 as “Web BLL”) to validate 465 the information provided by the user. Validation 465 may in an embodiment of the invention include, e.g., ensuring that all required information has been provided, that the information is internally consistent, and/or that the provided information satisfies some or all criteria for the user's eligibility to take part in the survey. It will be appreciated that some or all validation 465 may in an embodiment of the invention be done, e.g., by one or more scripts within the Web page 405 (e.g., in ECMAScript) in addition to or instead of that done by the Web application 460, and that some or all of such verification 465 may duplicate verification 465 done by the Web application 460.

The Web application 460 may provide 470 the results of the verification 465 operation. If the verification 465 is successful, the Web application 460 may store 475 some or all of the information, e.g., in one or more databases 480. If verification 465 fails, however, the Web application 460 may, e.g., cause one or more error messages to be presented 485 to the user 400, who may, in an embodiment of the invention, be prompted to fix the error before proceeding.

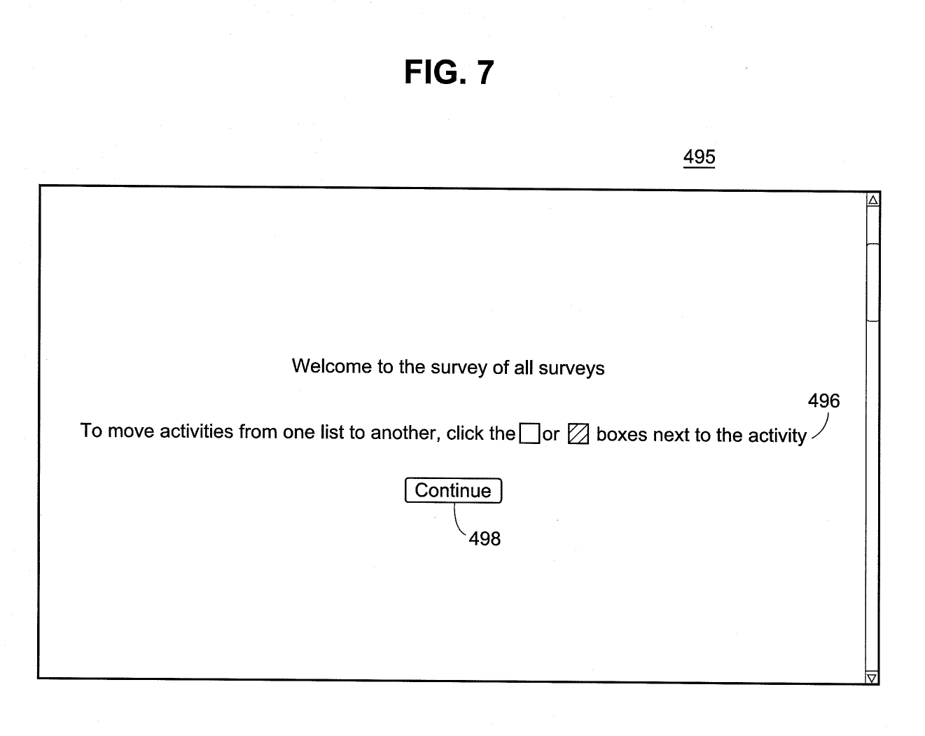

FIG. 7 depicts a display 495 that may be presented, e.g., to a user who is about to begin the survey proper. In an embodiment of the invention, a display 495 such as FIG. 7 depicts may be presented to the user after the user's demographic information has been accepted. Alternatively, in an embodiment of the invention, a session with a user may not begin with the user's provision of demographic information, and, in such an embodiment of the invention, a display 495 such as FIG. 7 depicts may be, e.g., the display that is initially presented to the user, e.g., when the user navigates to a Web page to begin the survey.

The display 495 may comprise, e.g., information and/or instructions 496 for the user. In the depicted embodiment of the invention, the user may begin the survey proper, e.g., by selecting the button 498 labeled “Continue.”

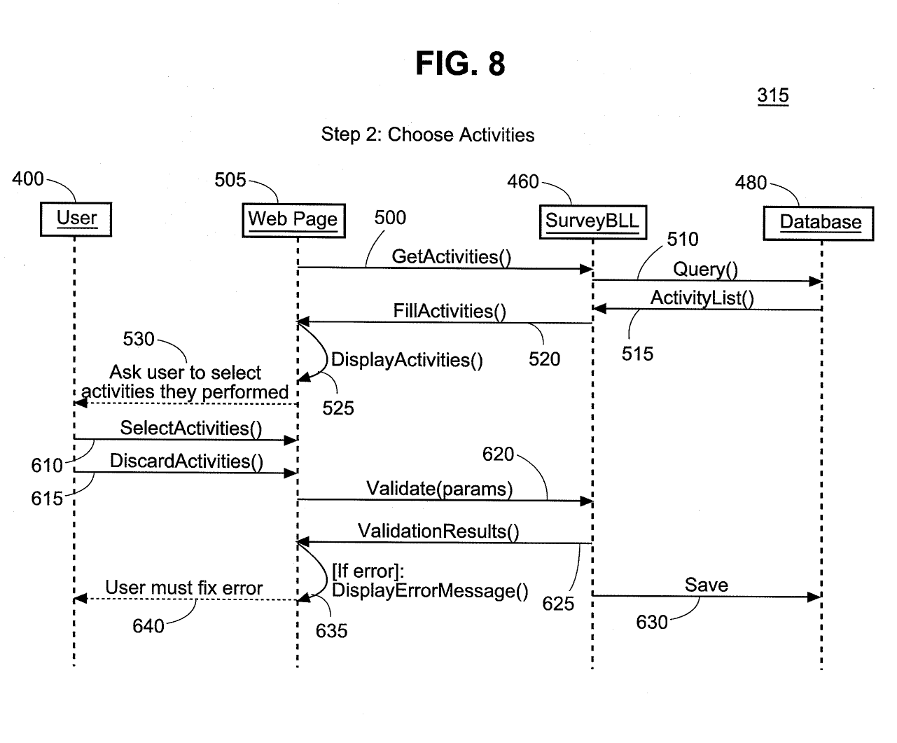

Following receipt and acceptance of the user's information, the user 400 may then in an embodiment of the invention be asked to select 350 from a list of activities. FIG. 8 depicts the sequence of such selection 315 according to an embodiment of the invention.

In an embodiment such as FIG. 8 depicts, the Web application 460 is asked for a list of activities for inclusion in a Web form 505. In response, the Web application 460 may send a query 510 to a database 480 to obtain such a list. The database 480 may then provide 515 a list such as requested. It will be appreciated that the contents of the list of activities may in an embodiment of the invention vary, e.g., depending on the information previously provided by the user. The contents of the list may vary based on one or more other criteria in addition to or instead of some or all of the information provided by the user and may in an embodiment of the invention vary randomly between different users participating in the same survey.

For example, in one embodiment of the invention, the list of activities may include: “Attended an informal party”, “Attended a religious service”, “Attended a sporting event”, “Attended a theatrical event”, “Attended a wedding”, “Beach”, “Big box store shopping (Target, Wal-Mart, etc.)”, “Boating”, “Bought a lottery ticket”, “Bought a new TV, cell phone or music player”, “Bought a ring tone”, “Bought clothes”, “Bowling”, “Casual Dining at Chain Restaurant (Applebee's, TGI Friday's, etc.)”, “Casual Dining at local restaurant (pizza, Chinese, etc.)”, “Commuted to work”, “Department store shopping”, “Did a home repair job”, “Did a regular exercise program”, “Did charity work”, “Did home improvements”, “Did volunteer work”, “Dine at a high-end restaurant”, “Downloaded music”, “Entertained at home”, “Fishing”, “Gambled”, “Gardening”, “Golf”, “Got a traffic ticket”, “Grocery shopping”, “Had car/truck serviced”, “Hosted a party”, “Ice skating”, “Listened to music”, “Mall shopping”, “Planned a birthday party”, “Played baseball”, “Played basketball”, “Played football”, “Played golf”, “Played hockey”, “Played soccer”, “Played volleyball”, “Purchased an MP3”, “Purchased furniture”, “Purchased gardening materials”, “Purchased sporting goods”, “Put Gas in the car/truck”, “Quading”, “Read a book”, “Read a newspaper”, “Rented a movie from a movie rental store (Blockbuster, local video store, etc.)”, “Rented a movie from your cable or satellite provider”, “Roller skating”, “Running”, “Sent a text message”, “Sent an email from a computer”, “Sent an email from a phone”, “Sent or received a picture on a cell phone”, “Sent/Received text messages”, “Shopped at a Home Improvement Store (Home Depot, Lowes, etc.)”, “Shopped at local home improvement store”, “Shopped online”, “Skiing”, “Sledding”, “Snowboarding”, “Snowmobiling”, “Spent time with extended family”, “Surfed the web”, “Swimming”, “Take out (pizza, Chinese, etc)”, “Talked to friends on the phone”, “Took a day trip”, “Took a walk”, “Took children to activities”, “Took children to/picked up from school”, “Trip to a local park”, “Used a cell phone”, “Used a home phone”, “Used GPS”, “Vacation”, “Walking”, “Went on a cruise”, “Went on a picnic”, “Went online”, “Went out to dinner with friends”, “Went to a concert”, “Went to a museum/aquarium, etc.”, “Went to a play”, “Went to a sporting event”, “Went to an amusement park”, “Went to the library”, “Went to the movies”, “Went to Work”, “Worked on my car”, “Worked out at home”, and “Worked Out at the gym”.

Although the list of items is referred to above and elsewhere herein as a list of activities, the reference to activities and the listing of particular activities are illustrative and not limiting.

Having received 515 the list of activities, in an embodiment of the invention, the Web application 460 may provide 520 the list or a subset thereof for inclusion in, e.g., a Web page 505 such as an HTML form, which may then be displayed 525 to the user 400. The Web page 505 may ask 530 the user 400 to identify from among the listed activities those that the user 400 performed or took part in within a specified interval of time.

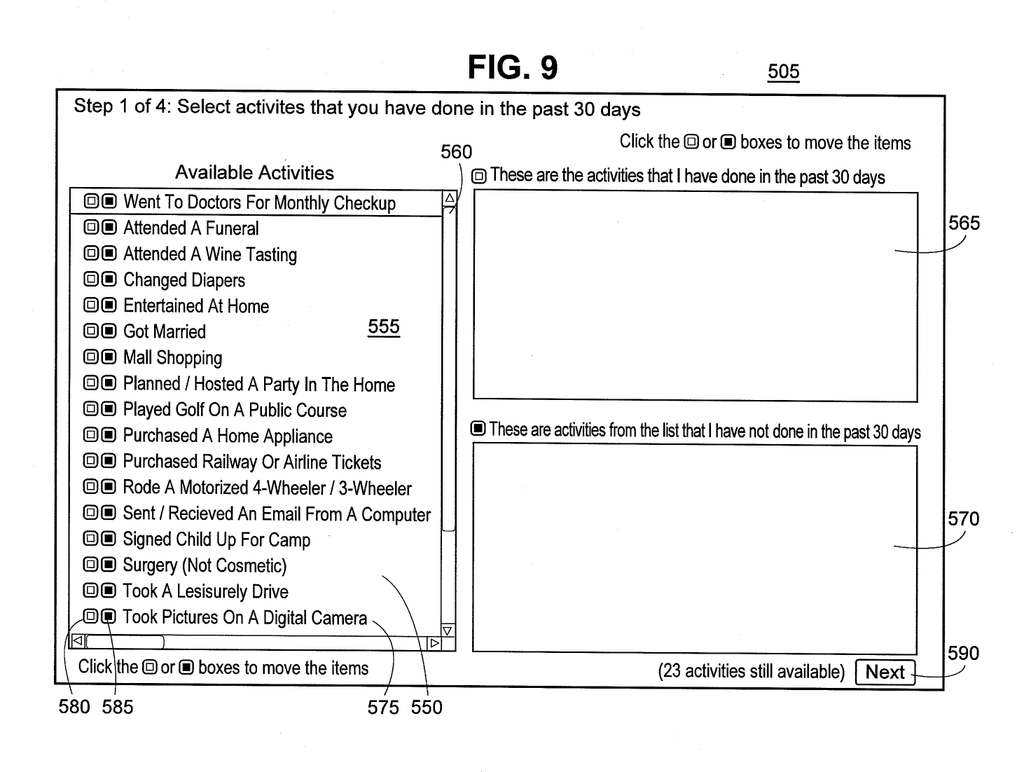

FIG. 9 depicts a Web page 505 such as may be presented to the user 400 in connection with this part of a method according to an embodiment of the invention. The page 505 may comprise an element 550 that presents a list of activities 555 to the user 400. As depicted, the list 555 is too long to be presented wholly within the control 550, so the control 550 comprises a scroll bar 560, which may allow the user to view parts of the list 555 before and/or after those that are currently displayed.

In an embodiment of the invention such as FIG. 9 depicts, the Web page comprises two other elements: one that may contain a list of selected activities 565 and another that may contain a list of discarded activities 570. An entry for an activity 575 may include an element 580, that, when selected by the user, may move that entry 575 from the original list 555 to the list of selected activities 565. The entry 575 may include another control 580 that, when selected by the user, may move that entry 575 from the original list 555 to the list of discarded activities 570.

It will be appreciated that, as is known in the art, an embodiment of the invention may support adding and/or removing one or more activities from either or both lists using other forms of user input, such as, e.g., using a computer pointing device to perform, e.g., a “drag-and-drop” gesture. In an alternative presentation (not pictured), according to an embodiment of the invention, either or both of the list of selected activities 565 and the list of discarded activities 570 may be absent. In such an embodiment of the invention, the user may simply select items within a single list of activities 555, e.g., by multiple selection using computer input devices such as, e.g., a keyboard and/or pointing device.

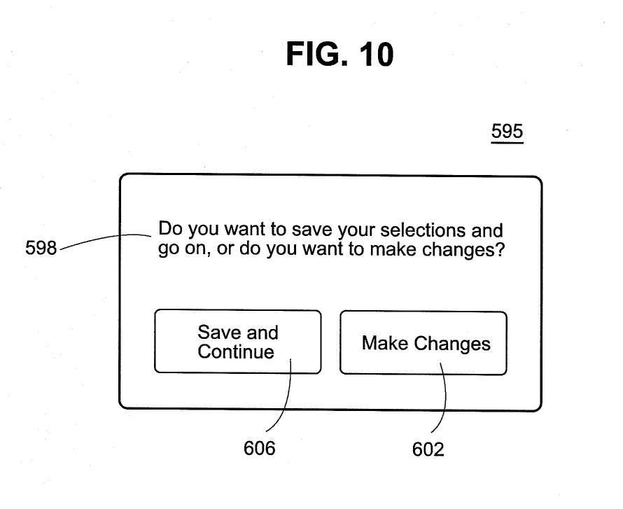

In the embodiment of the invention that FIG. 9 depicts, the Web page 505 includes a button labeled “Next” 590. In an embodiment of the invention, the user's selection of that button 590 may cause the appearance of a window (which may be referred to as a “confirmation dialog”). FIG. 10 depicts a confirmation dialog 595 according to an embodiment of the invention. The dialog 595 in an embodiment of the invention may include, e.g., an explanatory and/or instructional message 598, a button control 602 that may return to the display 505 of FIG. 9, and another button control 606 that may cause submission of the HTML form 505 to a Web server.

Returning to FIG. 8, selection of the “Save & Continue” button 606 in the confirmation dialog 595 may in an embodiment of the invention cause submission of the selected activities 610 and/or submission of the discarded activities 615. In an embodiment of the invention such as FIG. 8 depicts, either or both submissions 610, 615 may be explicit. Alternatively, in an embodiment of the invention, the identities of some or all of the selected and/or discarded activities may be implicit in the information provided as the Web page 505 is submitted.

In an embodiment of the invention, implicit or explicit submission of the information provided to the HTML form in the Web page 505 may in an embodiment of the invention cause, e.g., the Web application 460 to validate 620 the information provided by the user. At this stage, validation 620 may in an embodiment of the invention include, e.g., ensuring that all required information has been provided (e.g., that each of the activities has been either selected or discarded), and/or that the information is internally consistent. As before, some or all validation 620 may in an embodiment of the invention be done, e.g., by one or more scripts within the Web page 505 in addition to or instead of that done by the Web application 460, and that some or all of such verification 620 may duplicate verification 620 done by the Web application 460.

The Web application 460 may provide 625 the results of the verification 620 operation. If the verification 625 is successful, the Web application 460 may store 630 some or all of the information, e.g., in one or more databases 480. If verification 620 fails, however, the Web application 460 may, e.g., cause one or more error messages to be presented 635 to the user 400, who may, in an embodiment of the invention, be prompted 640 to fix the error before proceeding.

In connection with an embodiment of the invention, administration of a survey may be interrupted and resumed, e.g., hours, days, or months later. In an embodiment of the invention, a user's submission or submissions may be saved, e.g., as in the sequence that FIG. 8 depicts and/or at other points in the administration of a survey. A user may subsequently return to the survey, e.g., by providing a URL (not pictured) and/or other information to and/or via a Web browser, and thereby resume the survey where the user had previously left off.

Having identified the activities that the user 400 takes part in, the user 400 may in an embodiment of the invention be asked to narrow the list of activities. For example, in an embodiment of the invention, the user may be asked to select, e.g., the half of the activities that are most important to the user. The user may also be asked to estimate the amount of money spent on the activities in the selected half, e.g., individually or in aggregate.

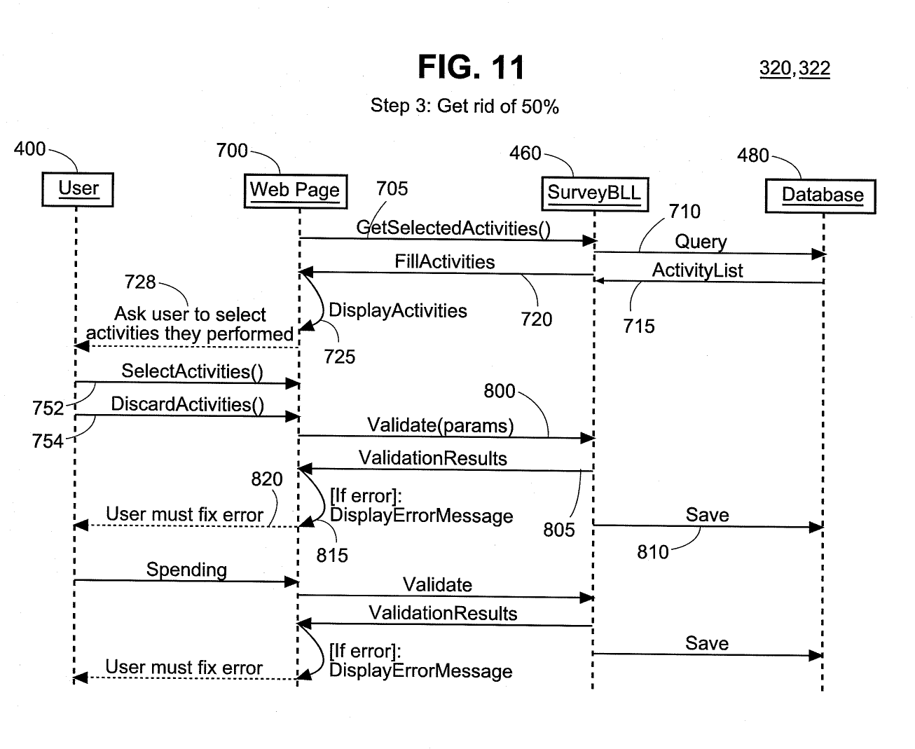

FIG. 11 depicts a sequence of obtaining this information 320 according to an embodiment of the invention. In an embodiment of the invention, this information may be obtained, e.g., by a Web page 700 that includes one or more HTML forms. Preparing the Web page 700 may entail requesting 705 the previously-selected items from the Web application 460. To obtain the requested information, the Web application 460 may send 710 a query, e.g., to a database 480, e.g., to retrieve the previously stored response. In response to the query, the database 480 may provide 715 the requested information to the Web application 460. The Web application 460 may in turn provide 720 that information for use in generating the Web page 700, which may then be presented 725, e.g., to the user 400 and may, e.g., ask 728 the user 400 to narrow the selection of activities.

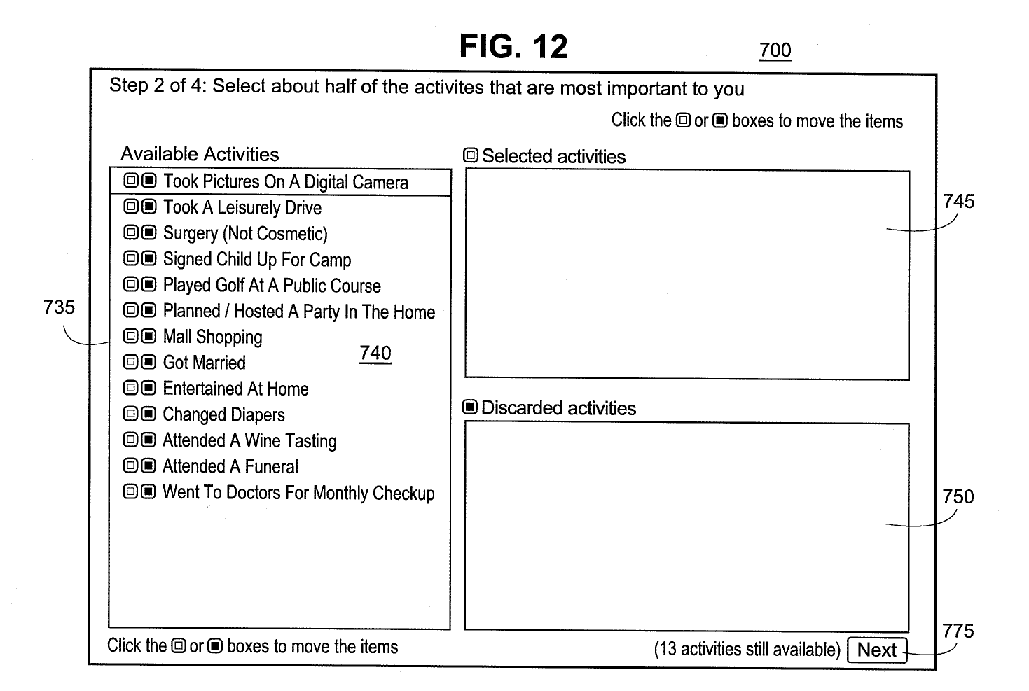

FIG. 12 depicts a Web page 700 such as may be presented to the user 400 to obtain the information according to an embodiment of the invention. The depicted page 700 includes a caption 730 that indicates a requested action to the user. Here, for example, the user 400 is asked to “Select about half of the activities that are most important to you.” In an embodiment of the invention, one or more other criteria may be presented in addition to or instead of the relative importance of the activities to the user 400.

The layout and elements of the Web page 700 in the embodiment of the invention that FIG. 9 depicts resemble in form and function that of the Web page 505 that FIG. 7 depicts. The page 700 may comprise an element 735 that presents a list of activities 740 to the user 400. The list 740 may in an embodiment of the invention be, e.g., the list of selected activities that the user 400 previously created in the control 565 (FIG. 9) that was created, e.g., through the sequence 315 depicted in FIG. 8.

The Web page 700, as depicted in FIG. 12, comprises two other elements: one that may contain a list of selected activities 745 and another that may contain a list of discarded activities 750. In an embodiment of the invention, activities from the list 740 may be selected 752 (FIG. 8) and/or discarded 754 (FIG. 8), e.g., in one or more of the ways depicted in connection with FIG. 9. A button 775, labeled “Next” in FIG. 12, may, as discussed in connection with FIGS. 8 and 9, cause a confirmation dialog (not pictured) to appear, which in turn may return to the display 700 that FIG. 12 depicts or cause submission of the HTML form 700 to a Web server.

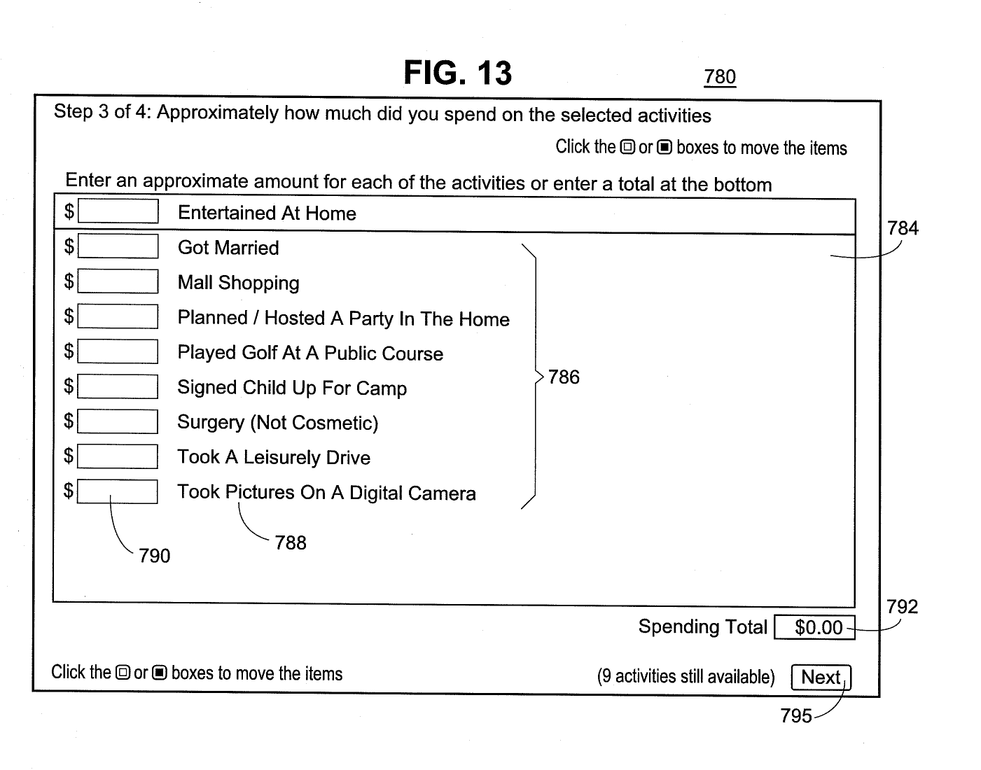

In an embodiment of the invention, the user may be asked to specify 322 individually the amounts spent on each of the activities selected by the user as most important. FIG. 13 depicts a Web page 780 such as may collect that information in an embodiment of the invention. For example, in an embodiment of the invention, a list 784 may present the activities 786 that were selected, e.g., as in FIG. 12. As depicted, each activity 788 may be presented e.g., next to a text area 790 in which the user 400 may enter an amount. Another text area 792 may present, e.g., the sum of the entered amounts, and this amount may be updated, e.g., automatically by one or more scripts executed by the browser, as the user 400 enters and/or edits the amounts. Other suitable ways to solicit and record this information are known in the art.

A button 795, labeled “Next” in FIG. 13, may, as discussed in connection with FIGS. 8 and 9, cause a confirmation dialog (not pictured) to appear, which in turn may return to the display 780 that FIG. 12 depicts or cause submission of the HTML form 780 to a Web server.

As before, submission of the information provided to the HTML form in the Web page 700 may in an embodiment of the invention cause, e.g., the Web application 460 to validate 800 the information provided by the user. As before, validation 800 may in an embodiment of the invention include, e.g., ensuring that all required information has been provided (e.g., that half of the presented activities have been selected and half of them discarded and that all required monetary estimates have been made), and/or that the information is internally consistent. As before, some or all validation 800 may in an embodiment of the invention be done, e.g., by one or more scripts within the Web page 700 in addition to or instead of that done by the Web application 460, and that some or all of such verification 800 may duplicate verification 800 done by the Web application 460.

The Web application 460 may provide 805 the results of the verification 800 operation. If the verification 800 is successful, the Web application 460 may store 810 some or all of the information. If verification 800 fails, however, the Web application 460 may, e.g., cause one or more error messages to be presented 815 to the user 400, who may, in an embodiment of the invention, be prompted 820 to fix the error before proceeding.

In an embodiment of the invention, the monetary information may be recorded and validated separately, e.g., as FIG. 8 depicts. Alternatively, in an embodiment of the invention (not depicted), the monetary information provided by the user 400 through a suitably modified version of the form (not pictured) in the Web page 700 that FIG. 12 depicts. In such an embodiment of the invention, the monetary information may be, e.g., validated and recorded as part of validating the selection of activities.

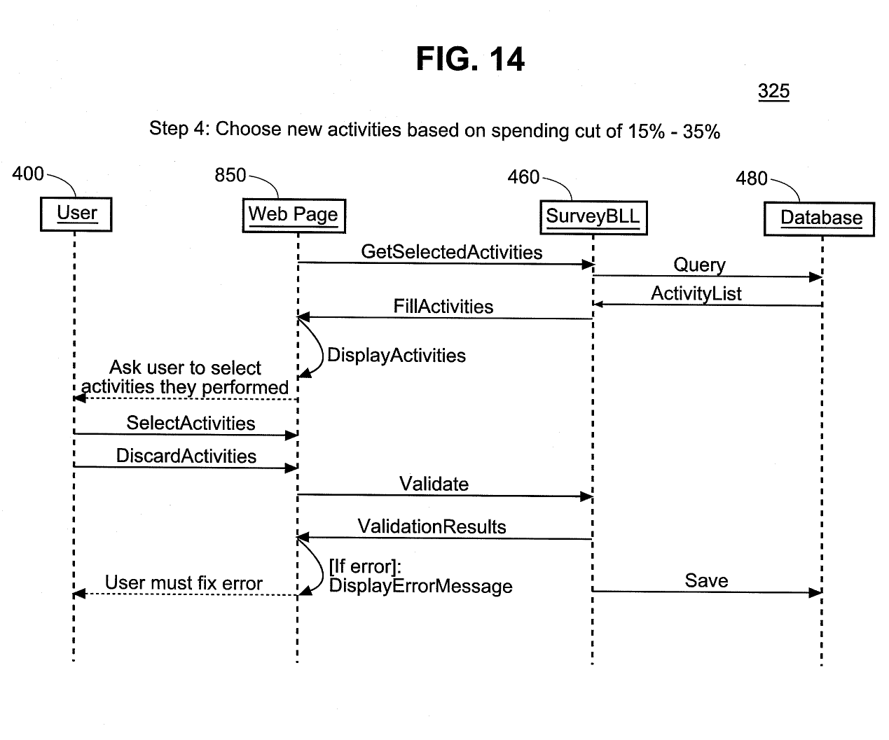

The user 400 may in an embodiment of the invention be asked to indicate which of the preferred activities that the user 400 would keep if the user 400 had to reduce the spending to a specified amount. For example, in some embodiments of the invention, the specified amount may be, e.g., 65% to 85% of the amount provided in the sequence 320 that FIG. 11 depicts. FIG. 14 depicts a sequence 325 of obtaining this information in an embodiment of the invention.

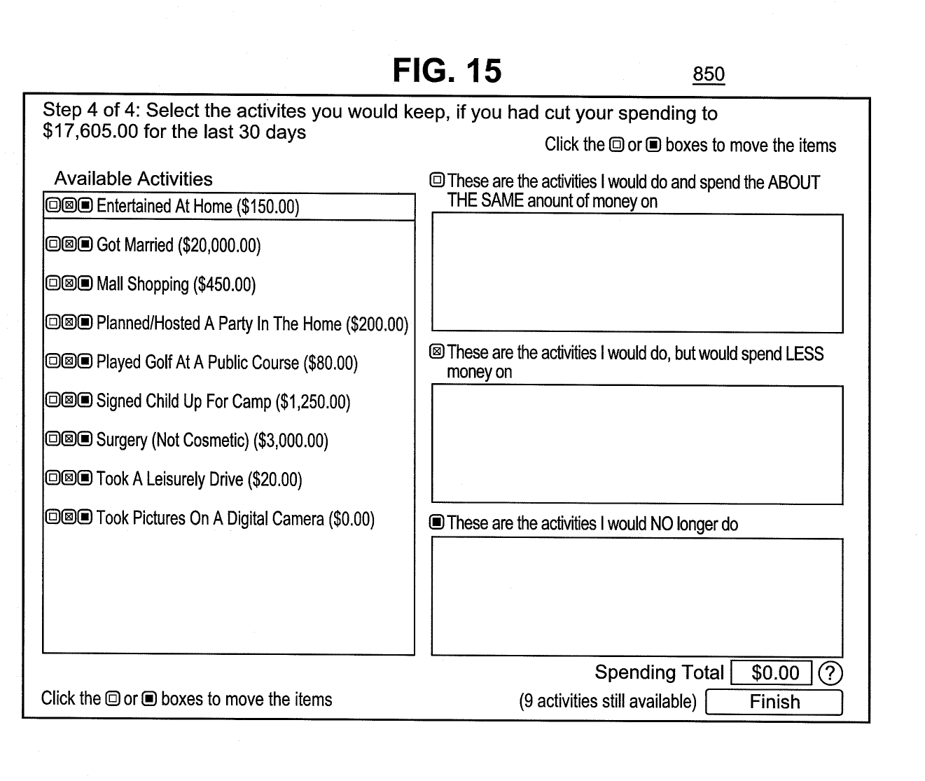

The information may be solicited, retrieved, and possibly validated, e.g., using an HTML form in a Web page 850 such as FIG. 15 depicts. It will be apparent that in an embodiment of the invention such as FIGS. 14 and 15 depict, the layout and function of elements in the page 850 may correspond, suitably modified, e.g., to those in the page 505 that FIG. 9 depicts and/or the page 770 that FIG. 12 depicts. Similarly, the steps in the sequence 325 may correspond, suitably modified, e.g., to similarly-labeled steps in the sequence 315 that FIG. 8 depicts and/or to those in the sequence 320 that FIG. 11 depicts.

It will be apparent that some, any, or all information gathered or generated in the course of administering a survey according to an embodiment of the invention may be recorded and/or indexed, e.g., persistently in one or more databases, in an embodiment of the invention. Any stored information may in an embodiment of the invention may be retrieved, analyzed, and/or reported, e.g., as known in the art.

It will be apparent to those skilled in the relevant arts that many variations of the foregoing are possible without departing from the spirit of the claimed invention. The foregoing description of certain embodiments of the invention is meant to be illustrative, not limiting. The scope of a claimed invention is therefore to limited only by the claims.

1. A method of administering a survey to a user in connection with a computer system that comprises one or more processors, one or more databases operatively coupled to at least one of the processors, a computer-readable storage medium storing instructions capable of being executed by at least one of the processors and operatively coupled to at least one of the processors, and one or more interfaces operatively coupled to at least one of the processors, the method comprising:
transmitting through at least one of the interfaces information to cause an electronic display device to present a plurality of items from a list to the user;
receiving through at least one of the interfaces first user input that indicates selection of a first selected plurality of presented items;
in response to receiving the first user input, transmitting through at least one of the interfaces information to cause an electronic display device to present the first selected plurality of selected items;
receiving through at least one of the interfaces second user input that indicates selection of a second selected plurality of presented items, the second selected plurality of presented items being a subset of the first selected plurality of presented items, the number of items in the second selected plurality of presented items having a previously specified relation to the number of items in the first selected plurality of presented items; and
at least one of the processors executing instructions retrieved from the computer-readable storage medium that cause information associated with the second user input to be stored in at least one of the databases.

2. The method of claim 1, comprising:
receiving through at least one of the interfaces third user input comprising a quantity representing an aggregate quantity associated with the items in the second selected plurality of presented items;
transmitting through at least one of the interfaces information to cause an electronic display device to present the second selected plurality of selected items and a reduced quantity that has a predetermined relation to the aggregate quantity;
receiving through at least one of the interfaces fourth user input comprising selection of a third selected plurality of presented items, the third selected plurality of presented items being a subset of the second selected plurality of presented items; and
at least one of the processors executing instructions retrieved from the computer-readable storage medium that cause information associated with the fourth user input to be stored in at least one of the databases.

3. The method of claim 1, comprising:
receiving through at least one of the interfaces third user input comprising a plurality of quantities, each of the items in the second selected plurality of presented items being associated respectively with one of the quantities;
at least one of the processors executing instructions retrieved from the computer-readable storage medium to calculate a first sum comprising the respectively associated quantity for each of the items in the second selected plurality of presented items;
transmitting through at least one of the interfaces information to cause an electronic display device to present the second selected plurality of selected items, each of the items in the second selected plurality of selected items being presented in association with the quantity associated with the respective item;
receiving through at least one of the interfaces fourth user input comprising selection of a third selected plurality of presented items, the third selected plurality of presented items being a subset of the second selected plurality of presented items, the sum of the quantities associated respectively with the items in the third selected plurality of presented items having a previously specified relation to the first sum; and
at least one of the processors executing instructions retrieved from the computer-readable storage medium that cause information associated with the fourth user input to be stored in at least one of the databases.

4. The method of claim 3, wherein each of the items identifies a particular activity that a person may take part in.

5. The method of claim 4, comprising:
receiving through at least one of the interfaces demographic information associated with the user; and
at least one of the processors executing instructions retrieved from the computer-readable storage medium that cause the demographic information to be stored in at least one of the databases; wherein
the list has been selected based on the demographic information.

6. The method of claim 4, wherein each quantity associated with a respective activity designates an amount of money spent by the user on the activity within a specified period of time.

7. The method of claim 4, wherein each quantity associated with a respective activity designates an amount of time spent by the user on the activity within a specified period of time.

8. The method of claim 6 or claim 7, wherein the number of items in the second selected plurality of presented items is approximately half of the number of items in the first selected plurality of presented items.

9. The method of claim 6 or claim 7, wherein the sum of the quantities associated respectively with the items in the third selected plurality of presented items is between sixty-five percent and eighty-five percent of the first sum.

10. A computer system for administering a survey to a user, the system comprising:
one or more processors;
one or more databases operatively coupled to at least one of the processors;
one or more interfaces operatively coupled to at least one of the processors; and
a computer-readable medium operatively coupled to at least one of the processors and storing instructions capable of being executed by at least one of the processors that, when executed by at least one of the processors, cause the computer system at least to:
transmit information to cause an electronic display device to present a plurality of items from a list to the user;
receive first user input that indicates selection of a first selected plurality of presented items;
in response to receiving the first user input, transmit information to cause an electronic display device to present the first selected plurality of selected items;
receive second user input that indicates selection of a second selected plurality of presented items, the second selected plurality of presented items being a subset of the first selected plurality of presented items, the number of items in the second selected plurality of presented items having a previously specified relation to the number of items in the first selected plurality of presented items; and
cause information associated with the second user input to be stored in at least one of the databases.

11. The computer system of claim 10, wherein the computer-readable medium stores instructions capable of being executed by at least one of the processors that, when executed by at least one of the processors, cause the computer system at least to:
receive through at least one of the interfaces third user input comprising a quantity representing an aggregate quantity associated with the items in the second selected plurality of presented items;
transmit through at least one of the interfaces information to cause an electronic display device to present the second selected plurality of selected items and a reduced quantity that has a predetermined relation to the aggregate quantity;
receive through at least one of the interfaces fourth user input comprising selection of a third selected plurality of presented items, the third selected plurality of presented items being a subset of the second selected plurality of presented items; and
cause information associated with the fourth user input to be stored in at least one of the databases.

12. The computer system of claim 10, wherein the computer-readable medium stores instructions capable of being executed by at least one of the processors that, when executed by at least one of the processors, cause the computer system at least to:
receive through at least one of the interfaces third user input comprising a plurality of quantities, each of the items in the second selected plurality of presented items being associated respectively with one of the quantities;
calculate a first sum comprising the respectively associated quantity for each of the items in the second selected plurality of presented items;
transmit through at least one of the interfaces information to cause an electronic display device to present the second selected plurality of selected items, each of the items in the second selected plurality of selected items being presented in association with the quantity associated with the respective item;
receive through at least one of the interfaces fourth user input comprising selection of a third selected plurality of presented items, the third selected plurality of presented items being a subset of the second selected plurality of presented items, the sum of the quantities associated respectively with the items in the third selected plurality of presented items having a previously specified relation to the first sum; and
cause information associated with the fourth user input to be stored in at least one of the databases.

13. The computer system of claim 12, wherein each of the items identifies a particular activity that a person may take part in.

14. The computer system of claim 13, wherein the computer-readable medium stores instructions capable of being executed by at least one of the processors that, when executed by at least one of the processors, cause the computer system at least to:
receive through at least one of the interfaces demographic information associated with the user; and
cause the demographic information to be stored in at least one of the databases; wherein
the list has been selected based on the demographic information.

15. The computer system of claim 13, wherein each quantity associated with a respective activity designates an amount of money spent by the user on the activity within a specified period of time.

16. The computer system of claim 13, wherein each quantity associated with a respective activity designates an amount of time spent by the user on the activity within a specified period of time.

17. The computer system of claim 15 or claim 16, wherein the number of items in the second selected plurality of presented items is approximately half of the number of items in the first selected plurality of presented items.

18. The computer system of claim 15 or claim 16, wherein the sum of the quantities associated respectively with the items in the third selected plurality of presented items is between sixty-five percent and eighty-five percent of the first sum.

19. A computer-readable medium encoded with instructions that, when executed by one or more processors within a computer system that comprises one or more databases operatively coupled to at least one of the processors and one or more interfaces operatively coupled to at least one of the processors, cause the computer system at least to:
transmit information to cause an electronic display device to present a plurality of items from a list to the user;
receive first user input that indicates selection of a first selected plurality of presented items;
in response to receiving the first user input, transmit information to cause an electronic display device to present the first selected plurality of selected items;
receive second user input that indicates selection of a second selected plurality of presented items, the second selected plurality of presented items being a subset of the first selected plurality of presented items, the number of items in the second selected plurality of presented items having a previously specified relation to the number of items in the first selected plurality of presented items; and
cause information associated with the second user input to be stored in at least one of the databases.

20. The computer-readable medium of claim 19, encoded with instructions that, when executed by at least one of the processors, cause the computer system at least to:
receive through at least one of the interfaces third user input comprising a quantity representing an aggregate quantity associated with the items in the second selected plurality of presented items;
transmit through at least one of the interfaces information to cause an electronic display device to present the second selected plurality of selected items and a reduced quantity that has a predetermined relation to the aggregate quantity;
receive through at least one of the interfaces fourth user input comprising selection of a third selected plurality of presented items, the third selected plurality of presented items being a subset of the second selected plurality of presented items; and
cause information associated with the fourth user input to be stored in at least one of the databases.

21. The computer-readable medium of claim 19, encoded with instructions that, when executed by at least one of the processors, cause the computer system at least to:
receive through at least one of the interfaces third user input comprising a plurality of quantities, each of the items in the second selected plurality of presented items being associated respectively with one of the quantities;
calculate a first sum comprising the respectively associated quantity for each of the items in the second selected plurality of presented items;
transmit through at least one of the interfaces information to cause an electronic display device to present the second selected plurality of selected items, each of the items in the second selected plurality of selected items being presented in association with the quantity associated with the respective item;
receive through at least one of the interfaces fourth user input comprising selection of a third selected plurality of presented items, the third selected plurality of presented items being a subset of the second selected plurality of presented items, the sum of the quantities associated respectively with the items in the third selected plurality of presented items having a previously specified relation to the first sum; and
cause information associated with the fourth user input to be stored in at least one of the databases.

22. The computer-readable medium of claim 21, wherein each of the items identifies a particular activity that a person may take part in.

23. The computer-readable medium of claim 22, encoded with instructions that, when executed by at least one of the processors, cause the computer system at least to:
receive through at least one of the interfaces demographic information associated with the user; and
cause the demographic information to be stored in at least one of the databases; wherein
the list has been selected based on the demographic information.

24. The computer-readable medium of claim 22, wherein each quantity associated with a respective activity designates an amount of money spent by the user on the activity within a specified period of time.

25. The computer-readable medium of claim 22, wherein each quantity associated with a respective activity designates an amount of time spent by the user on the activity within a specified period of time.

26. The computer-readable medium of claim 24 or claim 25, wherein the number of items in the second selected plurality of presented items is approximately half of the number of items in the first selected plurality of presented items.

27. The computer-readable medium of claim 24 or claim 25, wherein the sum of the quantities associated respectively with the items in the third selected plurality of presented items is between sixty-five percent and eighty-five percent of the first sum.
